(19) United States
(12) Patent Application Publication
(10) Pub. No.: US 2026/0139971 A1
(43) Pub. Date: May 21, 2026

(54) SYSTEMS AND METHODS FOR CAPACITIVE ON-HEAD DETECTION

(71) Applicant: Bose Corporation, Framingham, MA (US)

(72) Inventors: Theodore Bennett, Brookline, NH (US); Peter Raymond Rossi, III, Richmond, RI (US); Benjamin Robert Hart, Brighton, MA (US); Arthur Mistler, Sutton, MA (US); David Kaphammer, Salem, MA (US)

(73) Assignee: Bose Corporation, Framingham, MA (US)

(21) Appl. No.: 18/948,837

(22) Filed: Nov. 15, 2024

(51) Int. Cl. G01D 5/24; H04R 1/10

(52) U.S. Cl. CPC G01D 5/24; H04R 1/1008

(57) ABSTRACT

A wearable audio device is provided. The wearable audio device includes a first capacitive proximity sensor. The first capacitive proximity sensor is configured to generate a raw proximity signal. The wearable audio device further includes a second capacitive proximity sensor. The second capacitive proximity sensor is configured to generate a raw reference signal. The wearable audio device further includes a controller. The controller is configured to calculate a proximity threshold. The proximity threshold is calculated based on a product adjustment ratio, a bias value, and the raw reference signal. The controller is further configured to determine an on-head status. The on-head status is determined based on the raw proximity signal and the proximity threshold.

### FIELD OF THE DISCLOSURE

The present disclosure is generally directed to capacitive on-head detection of a wearable audio device, and more specifically, to compensating for temperature effects using a reference capacitive sensor.

### BACKGROUND

On-head detection systems are configured to determine if a wearable audio device is being worn on the head of a user. The on-head detection system may use a capacitive proximity sensor to determine if the wearable device is being worn. However, the thermal effects can impact the capacitance measurements captured by the capacitive proximity sensor, leading to inaccurate on-head detection. These thermal effects may originate from parasitic capacitances of a circuit board (such as a flexible circuit board) on which the capacitive proximity sensor is mounted, or from the body temperature of the user wearing the wearable audio device.

### SUMMARY

The present disclosure is generally directed to systems and methods for capacitive on-head detection of a wearable audio device. In particular, the present disclosure describes compensating for temperature effects using a reference capacitive sensor. The wearable audio device includes a capacitive proximity sensor, a capacitive reference sensor, and a controller coupled to the capacitive proximity sensor and the capacitive reference sensor. The capacitive proximity sensor provides the controller with a raw proximity signal based on a first self-capacitance measurement, while the capacitive reference sensor provides the controller with a raw reference signal based on a second self-capacitance measurement. The controller then calculates a proximity threshold based on a product adjustment ratio, a bias value, and the raw reference signal. The product adjustment ratio is used to compensate for temperature effects shown over several (or more) devices of a particular model, such as several earbuds or wireless headsets. The product adjustment ratio may be determined by dividing an average of a plurality of off-head proximity signals corresponding to several different devices by an average of a plurality of off-head reference signals also corresponding to the same devices. The bias value is used to calibrate the particular wearable being evaluated for on-head status. The bias value may be determined by subtracting the product of an off-head reference signal for the device being analyzed and the product adjustment ratio from an off-head proximity signal for the device. The proximity threshold is then determined by adding the product of the product adjustment ratio and the raw reference signal to the bias value. The on-head status of the wearable audio device is then determined by comparing the raw proximity signal to the proximity threshold. If the raw proximity threshold exceeds the proximity threshold by a predetermined difference value, the wearable audio device is determined to be arranged on the head of a user.

In some embodiments, the capacitance proximity sensor is configured as an electrode arranged on a first side of a flexible circuit board (FCB), while the capacitive reference sensor is configured as an electrode arranged on the second side of the FCB, opposite of and parallel to the capacitive proximity sensor. In other examples, the capacitive proximity sensor and the capacitive reference sensor may be arranged on the same side of the FCB. The capacitive proximity sensor is typically significantly larger in area than the capacitive reference sensor. Further, if the wearable audio device is an audio headset, the PCB may be arranged within a first earcup, such that that capacitive proximity sensor is closer to the head of the user when the wearable audio device is worn.

Generally, in one example, a wearable audio device is provided. The wearable audio device includes a first capacitive proximity sensor. The first capacitive proximity sensor is configured to generate a raw proximity signal.

The wearable audio device further includes a second capacitive proximity sensor. The second capacitive proximity sensor is configured to generate a raw reference signal.

The wearable audio device further includes a controller. The controller is configured to calculate a proximity threshold. The proximity threshold is calculated based on a product adjustment ratio, a bias value, and the raw reference signal.

The controller is further configured to determine an on-head status. The on-head status is determined based on the raw proximity signal and the proximity threshold.

According to an example, the raw proximity signal corresponds to a first self-capacitance measurement of the first capacitive proximity sensor. Further, the raw reference signal correspond to a second self-capacitance measurement of the second capacitive proximity sensor.

According to an example, the bias value is calculated based on an off-head proximity signal, an off-head reference signal, and the product adjustment ratio.

According to an example, the product adjustment ratio is based on a plurality of off-head proximity signals and a plurality of off-head reference signals corresponding to a plurality of wearable audio devices.

According to an example, the controller is electrically coupled to an acoustic transducer.

According to an example, the first capacitive proximity sensor is arranged on a first side of an FCB.

According to an example, the second capacitive proximity sensor is arranged on the first side of the FCB.

According to an example, the second capacitive proximity sensor is arranged on a second side of the FCB.

According to an example, the wearable audio device comprises a first ear cup, and wherein the FCB is at least partially arranged within the first ear cup.

According to an example, the first capacitive proximity sensor is larger than the second capacitive proximity sensor.

Generally, in another example, a method for on-head detection of a wearable audio device is provided. The method includes generating, via a first capacitive proximity sensor of the wearable audio device, a raw proximity signal.

The method further includes generating, via a second capacitive proximity sensor of the wearable audio device, a raw reference signal.

The method further includes calculating, via a controller of the wearable audio device, a proximity threshold based on a product adjustment ratio, a bias value, and the raw reference signal.

The method further includes determining, via the controller, an on-head status based on the raw proximity signal and the proximity threshold.

According to an example, the raw proximity signal corresponds to a first self-capacitance measurement of the first capacitive proximity sensor. The raw reference signal corresponds to a second self-capacitance measurement of the second capacitive proximity sensor.

According to an example, the bias value is calculated based on an off-head proximity signal, an off-head reference signal, and the product adjustment ratio.

According to an example, the product adjustment ratio is based on a plurality of off-head proximity signals and a plurality of off-head reference signals corresponding to a plurality of wearable audio devices.

According to an example, the controller is electrically coupled to an acoustic transducer.

According to an example, the first capacitive proximity sensor is arranged on a first side of an FCB.

According to an example, the second capacitive proximity sensor is arranged on the first side of the FCB.

According to an example, the second capacitive proximity sensor is arranged on a second side of the FCB.

According to an example, the wearable audio device comprises a first car cup, and wherein the FCB is at least partially arranged within the first car cup.

According to an example, the first capacitive proximity sensor is larger than the second capacitive proximity sensor.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a front view of a wearable audio device, in accordance with an example.

FIG. 2 is a functional block diagram of aspects of a system for on-head detection, in accordance with an example.

FIG. 3 is a top view of a flexible circuit board (FCB) having a first and second capacitive proximity sensor, in accordance with an example.

FIG. 4 is a flow chart of a method for on-head detection of a wearable device, in accordance with an example.

### DETAILED DESCRIPTION

The present disclosure is generally directed to systems and methods for capacitive on-head detection of a wearable audio device. In particular, the present disclosure describes compensating for temperature effects using a reference capacitive sensor. The wearable audio device includes a capacitive proximity sensor, a capacitive reference sensor, and a controller coupled to the capacitive proximity sensor and the capacitive reference sensor. The capacitive proximity sensor provides the controller with a raw proximity signal based on a first self-capacitance measurement, while the capacitive reference sensor provides the controller with a raw reference signal based on a second self-capacitance measurement. The controller then calculates a proximity threshold based on a product adjustment ratio, a bias value, and the raw reference signal. The product adjustment ratio is used to compensate for temperature effects shown over several (or more) devices of a particular model, such as several earbuds or wireless headsets. The bias value is used to calibrate the particular wearable being evaluated for on-head status. The proximity threshold is then determined by adding the product of the product adjustment ratio and the raw reference signal to the bias value. The on-head status of the wearable audio device is then determined by comparing the raw proximity signal to the proximity threshold. If the raw proximity threshold exceeds the proximity threshold by a predetermined difference value, the wearable audio device is determined to be arranged on the head of a user.

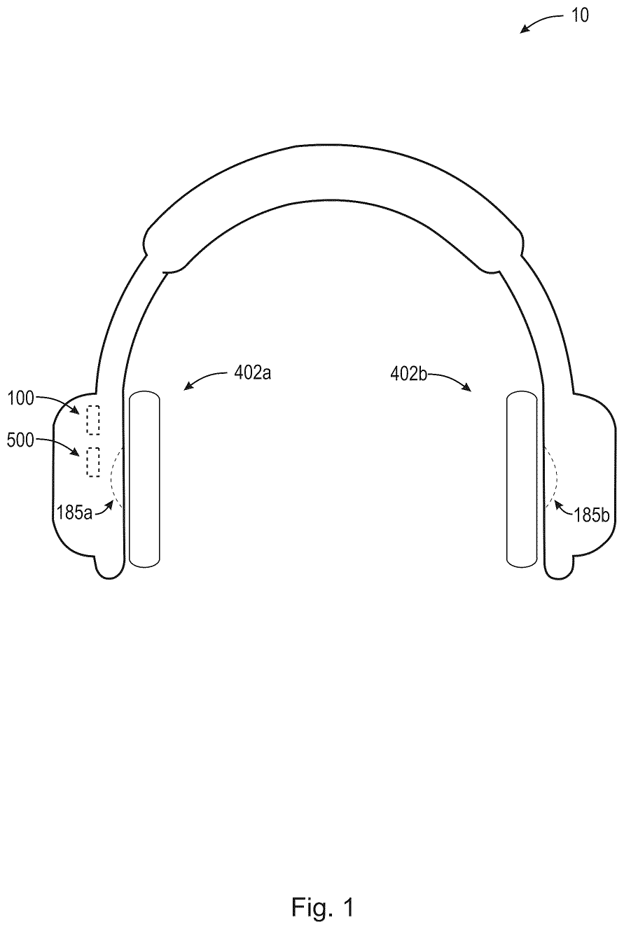

The following description should be read in view of FIGS. 1-4.

The term “wearable audio device,” as used in this application, in addition to including its ordinary meaning or its meaning known to those skilled in the art, is intended to mean a device that fits around, on, in, or near an ear (including open-car audio devices worn on the head or shoulders of a user) and that radiates acoustic energy into or towards the ear. Wearable audio devices are sometimes referred to as headphones, earphones, earpieces, headsets, earbuds or sport headphones, and can be wired or wireless. A wearable audio device includes an acoustic driver to transduce audio signals to acoustic energy. The acoustic driver can be housed in an earcup. While some of the figures and descriptions following can show a single wearable audio device, having a pair of earcups (each including an acoustic driver) it should be appreciated that a wearable audio device can be a single stand-alone unit having only one earcup. Each earcup of the wearable audio device can be connected mechanically to another earcup or headphone, for example by a headband and/or by leads that conduct audio signals to an acoustic driver in the war cup or headphone. A wearable audio device can include components for wirelessly receiving audio signals. A wearable audio device can include components of an active noise reduction (ANR) system. Wearable audio devices can also include other functionality such as a microphone so that they can function as a headset. While the non-limiting example of FIG. 1 depicts the wearable audio device 10 as an audio headset with a pair of ear cups, the wearable audio device 10 described below may be any of the aforementioned types of devices.

FIG. 1 illustrates a non-limiting example of a wearable audio device 10 as an audio headset. The wearable audio device 10 includes a left earcup 402a and a right earcup 402b. Each earcup 402a, 402b includes an acoustic transducer 185a, 185b configured to render audio to the user. Further, the wearable audio device 10 includes a controller 100. The controller 100 includes a processor and a memory and may be configured to perform a wide variety of tasks, such as providing audio to the acoustic transducers 185a, 185b to be rendered to the user. In some examples, the controller 100 may also include a receiver, transmitter, and/or transceiver to facilitate wireless communication with another device. Further, as will be described in more detail below, the controller 100 may also be configured to determine whether the wearable audio device 10 is currently being worn by the user.

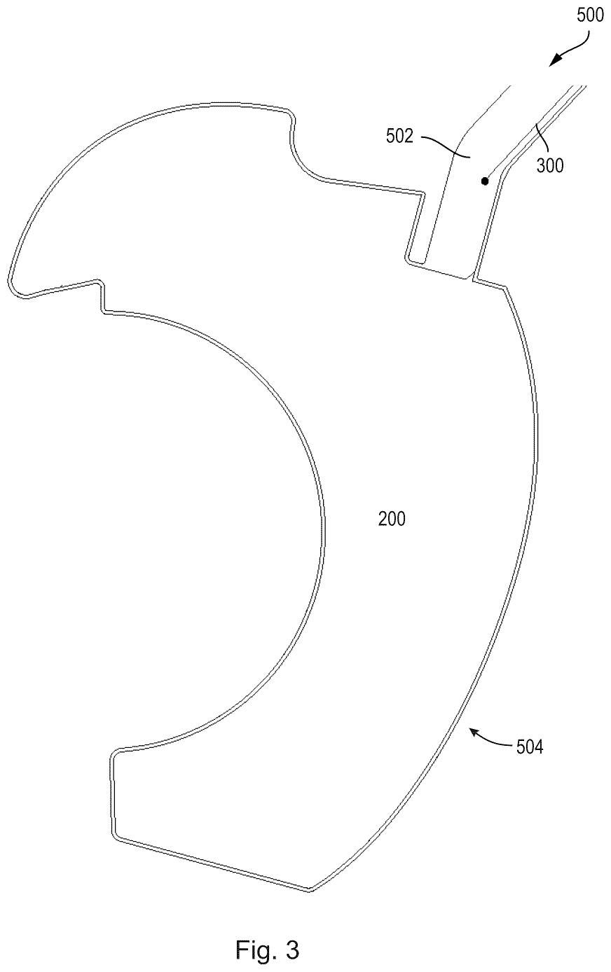

The controller 100 further includes a circuit board 500, such as a flexible circuit board (FCB) or a printed circuit board (PCB). The circuit board 500 includes a pair of capacitive proximity sensors 200, 300 (as shown in FIG. 3). The capacitive proximity sensors 200, 300 are used to determine whether the wearable audio device 10 is currently being worn by a user. In the non-limiting example of FIG. 1, the circuit board 500 carrying the proximity sensors 200, 300 is located within the left earcup 402a. In other examples, the circuit board 500 could be arranged within the right earcup 402b or within other aspects of the wearable audio device 10.

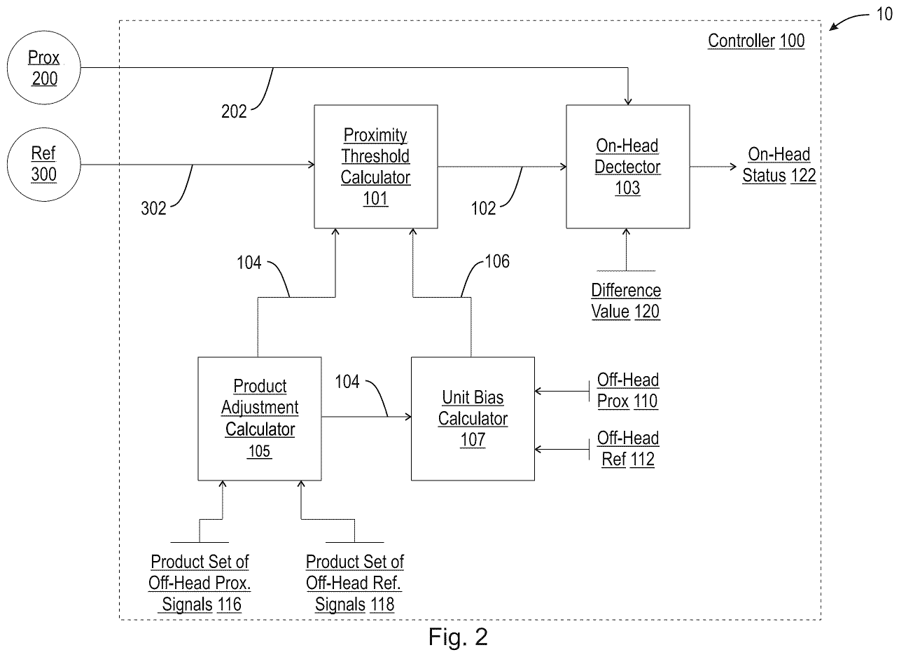

FIG. 2 is a functional block diagram showing aspects of a system for on-head detection. More particularly, FIG. 2 illustrates how the controller 100 of the wearable audio device 10 shown in FIG. 1 determines if the wearable audio device 10 is currently being worn by the user. As shown in the non-limiting example of FIG. 2, a first capacitive proximity sensor 200 provides the controller 100 with a raw proximity signal 202. In the examples, the first capacitive proximity sensor 200 may be simply referred to as the proximity sensor 200, while the second capacitive proximity sensor may be referred to as the reference sensor 300. Similarly, a second capacitive proximity sensor 300 provides the controller 100 with a raw reference signal 302. Both the raw proximity signal 202 and the raw reference signal 302 represent the self-capacitance measured by each of the respective proximity sensors 200, 300. Broadly, the second capacitive proximity sensor 300 is used to correct for temperature effects impacting the raw proximity signal 202 captured by the first capacitive proximity sensor 200. This is done by calculating a proximity threshold 102 and comparing the raw proximity signal 202 to the proximity threshold 102 to determine an on-head status 122 of the wearable audio device 10.

As shown in FIG. 2, the controller 100 includes a proximity threshold calculator 101, an on-head detector 103, a product adjustment calculator 105, and a unit bias calculator 107. Each of the aforementioned components may be implemented via any combination of hardware and/or software aspects of the controller 100. While the controller 100 of FIG. 2 is depicted as a single component or element, the functions of the controller 100 may be distributed over more than one component or element.

The proximity threshold calculator 101 calculates the proximity threshold 102 based on a product adjustment ratio 104, a bias value 106, and the raw reference signal 302. The product adjustment ratio 104 is used to compensate for temperature effects shown over several (or more) devices of a particular model, such as several earbuds or wireless headsets. The product adjustment calculator 105 determines the product adjustment ratio 104 based on a plurality of off-head proximity signals 116 corresponding to several (or more) different devices and a plurality of off-head reference signals 118 also corresponding to the same devices. In some examples, the product adjustment ratio 104 may be calculated by dividing an average of the off-head proximity signals 116 by an average of the off-head reference signals 118. Other statistical processing of the off-head proximity signals 116 and the off-head reference signals 118 may be performed to generate the product adjustment ratio 104. The off-head proximity signals 116 and the off-head reference signals 118 may be captured, shared, and stored by each of the different devices during a factory calibration process.

Further, the unit bias calculator 107 is used to calculate the bias value 106. The bias value 106 is used to calibrate the relationship of the first and second capacitive proximity sensors 200, 300 while the wearable audio device 10 is not being worn (also referred to as “off-head”) and operating at a nominal operating temperature. While the product adjustment ratio 104 is based on measurements captured by several different wearable audio devices of the same model, the bias value 106 is unique to the individual wearable audio device 100 being evaluated for on-head status 122. Further, like the product adjustment ratio 104, the bias value 106 is also determined based on measurements captured by the sensors 200, 300 while the wearable audio device 10 is in the off-head position.

As shown in FIG. 2, the bias value 106 is determined based on the product adjustment ratio 104, an off-head proximity signal 110, and an off-head reference signal 112. The off-head proximity signal 110 may be captured by the first capacitive proximity sensor 200 during the factory calibration process while the wearable audio device 10 is off-head. The off-head reference signal 112 may be captured by the second capacitive proximity sensor 300 during a factory calibration process while the wearable audio device 10 is off-head. In some examples, a plurality of off-head proximity signals 110 may be captured and synthesized into the off-head proximity signal 110. Similarly, a plurality of off-head reference signals 112 may be captured and synthesized into the off-head reference signal 112.

In some examples, the bias value 106 (BIAS) may be calculated by (1) multiplying the off-head reference signal 112 (OH REF) by the product adjustment ratio 104 (PAR) and (2) subtracting the product of step 1 from the off-head proximity signal 110 (OH PROX) as shown in Equation 1:

$$BIAS = OH PROX - ( P A R * OH REF ) \qquad Equation 1$$

The proximity threshold calculator 101 then determines the proximity threshold 102. The proximity threshold 102 is determined after the wearable audio device 10 leaves the factory setting and reaches the end user. The proximity threshold 102 is calculated based on the product adjustment ratio 104, the bias value 106, and the raw reference signal 302 captured by the reference sensor 300.

In some examples, the proximity threshold (PTH) 102 may be calculated by (1) multiplying the product adjustment ratio 104 by the raw reference signal 302 (REF) and (2) adding the product of step 1 to the bias value 106 as shown in Equation 2:

$$P T H = ( P A R * R E F ) + BIAS \qquad Equation 2$$

The proximity threshold 102 is then provided to the on-head detector 103 to determine the on-head status 122 of the wearable audio device 10. As shown in FIG. 2, the on-head status 122 is determined based on the proximity threshold 102, a difference value 120, and the raw proximity signal 202 captured by the proximity sensor 200. The difference value 120 is a predetermined buffer value used to prevent false positive detections of the on-head status 122.

In some examples, the on-head status 122 is a binary value of ON or OFF. In these examples, the on-head status 122 is set to ON if the raw proximity signal 202 exceeds the sum of the proximity threshold 102 and the difference value 120 for a predetermined time period or predetermined number of measurement samples. Otherwise, the on-head status 122 is set to OFF.

In some examples, the on-head status 122 could be used to control or influence other aspects of the wearable audio device 10. In some examples, if the on-head status 122 is ON, the controller 100 may trigger one or both of the acoustic transducers 185a, 185b to provide feedback to the user indicating that the wearable audio device 10 is detected as being worn. The on-head status 122 of ON may also trigger the acoustic transducers 185a, 185b to generate other types of audio, such as phone call audio or entertainment audio (corresponding to music, podcasts, etc.). In other cases, if the on-head status 122 is OFF, the controller 100 may temporarily disable certain features of the wearable audio device 10 to conserve battery power. These features may be enabled when the on-head status 122 is ON.

FIG. 3 is a top view of an FCB 500 arranged within the wearable audio device 10. The FCB 500 may be defined by a first side 502. The FCB 500 may be further defined by a second side 504 opposite and parallel to the first side 502. In some examples, the first side 502 may be considered to be the top side of the FCB 500, and the second side 504 may be considered to be the bottom side of the FCB 500. In some examples, and as shown in FIG. 1, the FCB 500 may be arranged within an earcup 402 of the wearable audio device 10. In some examples, the FCB 500 may instead be a nonflexible printed circuit board (PCB). As shown in FIG. 3, the proximity sensor 200 is embodied as an electrode arranged over a significant portion of the first side 502 the FCB 500. FIG. 3 further illustrates the reference sensor 300 as also arranged on the first side 502 of the FCB 500. As shown in FIG. 3, the reference sensor 300 may be embodied as a narrow metal trace having a much smaller surface area than the proximity sensor 200. Further, the proximity sensor 200, the reference sensor 300, and the FCB 500 may be arranged within the wearable audio device 10 in such a manner that the proximity sensor 200 is closer to the head of the user than the reference sensor 300 when the wearable audio device 10 is worn. The reference sensor 300 is positioned to be further from the head of the user to monitor and correct for ambient changes (such as thermal effects due to parasitic capacitances of the FCB 500) impacting the raw proximity signal 202 generated by the proximity sensor 200. In further examples, the proximity sensor 200 and the reference sensor 300 may be arranged on different sides of the FCB 500. For example, the proximity sensor 200 may be arranged on the first side 502, while the reference sensor 300 may be arranged on the second side 504.

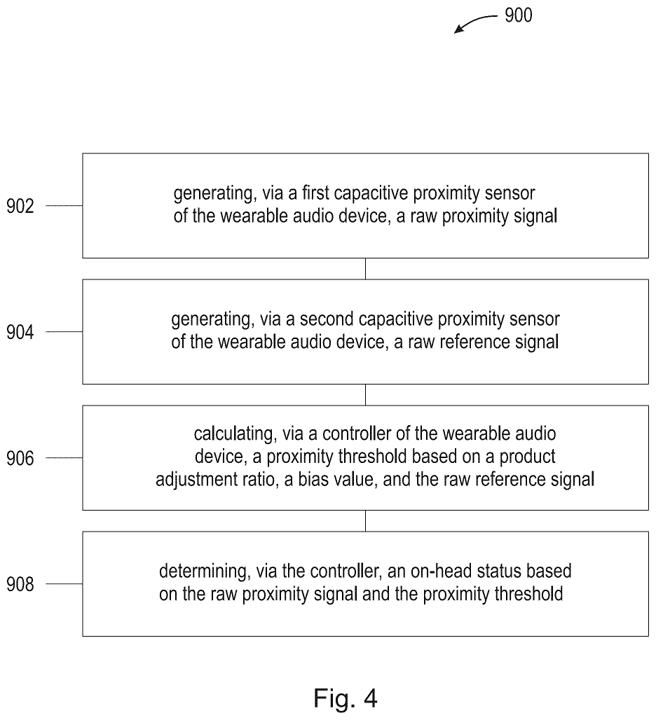

FIG. 4 is a flow chart of a method 900 for on-head detection of a wearable device. Referring to FIGS. 1-4, the method 900 includes, in step 902, generating, via a first capacitive proximity sensor 200 of the wearable audio device 10, a raw proximity signal 202.

The method 900 further includes, in step 904, generating, via a second capacitive proximity sensor 300 of the wearable audio device 10, a raw reference signal 302.

The method 900 further includes, in step 906, calculating, via a controller 100 of the wearable audio device 10, a proximity threshold 102 based on a product adjustment ratio 104, a bias value 106, and the raw reference signal 302.

The method 900 further includes, in step 908, determining, via the controller 100, an on-head status 122 based on the raw proximity signal 202 and the proximity threshold 102.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

What is claimed is:

1. A wearable audio device, comprising:
a first capacitive proximity sensor configured to generate a raw proximity signal;
a second capacitive proximity sensor configured to generate a raw reference signal;
a controller configured to:
calculate a proximity threshold based on a product adjustment ratio, a bias value, and the raw reference signal; and
determine an on-head status based on the raw proximity signal and the proximity threshold.

2. The wearable audio device of claim 1, wherein the raw proximity signal corresponds to a first self-capacitance measurement of the first capacitive proximity sensor, and wherein the raw reference signal correspond to a second self-capacitance measurement of the second capacitive proximity sensor.

3. The wearable audio device of claim 1, wherein the bias value is calculated based on an off-head proximity signal, an off-head reference signal, and the product adjustment ratio.

4. The wearable audio device of claim 1, wherein the product adjustment ratio is based on a plurality of off-head proximity signals and a plurality of off-head reference signals corresponding to a plurality of wearable audio devices.

5. The wearable audio device of claim 1, wherein the controller is electrically coupled to an acoustic transducer.

6. The wearable audio device of claim 1, wherein the first capacitive proximity sensor is arranged on a first side of a flexible circuit board (FCB).

7. The wearable audio device of claim 6, wherein the second capacitive proximity sensor is arranged on the first side of the FCB.

8. The wearable audio device of claim 6, wherein the second capacitive proximity sensor is arranged on a second side of the FCB.

9. The wearable audio device of claim 6, wherein the wearable audio device comprises a first ear cup, and wherein the FCB is at least partially arranged within the first ear cup.

10. The wearable audio device of claim 1, wherein the first capacitive proximity sensor is larger than the second capacitive proximity sensor.

11. A method for on-head detection of a wearable audio device, comprising:
generating, via a first capacitive proximity sensor of the wearable audio device, a raw proximity signal;
generating, via a second capacitive proximity sensor of the wearable audio device, a raw reference signal;
calculating, via a controller of the wearable audio device, a proximity threshold based on a product adjustment ratio, a bias value, and the raw reference signal; and
determining, via the controller, an on-head status based on the raw proximity signal and the proximity threshold.

12. The method of claim 11, wherein the raw proximity signal corresponds to a first self-capacitance measurement of the first capacitive proximity sensor, and wherein the raw reference signal corresponds to a second self-capacitance measurement of the second capacitive proximity sensor.

13. The method of claim 11, wherein the bias value is calculated based on an off-head proximity signal, an off-head reference signal, and the product adjustment ratio.

14. The method of claim 11, wherein the product adjustment ratio is based on a plurality of off-head proximity signals and a plurality of off-head reference signals corresponding to a plurality of wearable audio devices.

15. The method of claim 11, wherein the controller is electrically coupled to an acoustic transducer.

16. The method of claim 11, wherein the first capacitive proximity sensor is arranged on a first side of a flexible circuit board (FCB).

17. The method of claim 16, wherein the second capacitive proximity sensor is arranged on the first side of the FCB.

18. The method of claim 16, wherein the second capacitive proximity sensor is arranged on a second side of the FCB.

19. The method of claim 16, wherein the wearable audio device comprises a first ear cup, and wherein the FCB is at least partially arranged within the first ear cup.

20. The method of claim 11, wherein the first capacitive proximity sensor is larger than the second capacitive proximity sensor.
